(19) United States
(12) Patent Application Publication
(10) Pub. No.: US 2026/0040059 A1
(43) Pub. Date: Feb. 5, 2026

(54) SUPPORTING SEAMLESS ROAMING FOR ENHANCED DATA PRIVACY WIRELESS STATIONS

(71) Applicant: Cisco Technology, Inc., San Jose, CA (US)

(72) Inventors: Domenico FICARA, Essertines-Sur-Yverdon (CH); Javier I. CONTRERAS ALBESA, Sant Cugat del Valles (ES); Ugo M. CAMPIGLIO, Morges (CH); Jerome HENRY, Pittsboro, NC (US); Federico LOVISON, Fontanelle (IT)

(21) Appl. No.: 19/281,566

(22) Filed: Jul. 26, 2025

Related U.S. Application Data
(60) Provisional application No. 63/678,014, filed on Jul. 31, 2024.
(60) Provisional application No. 63/677,982, filed on Jul. 31, 2024.

(51) Int. Cl. H04W 12/02

(52) U.S. Cl. CPC H04W 12/02

(57) ABSTRACT

Techniques and apparatus for supporting seamless roaming for enhanced privacy wireless stations are described. An example technique performed by a wireless station includes obtaining, while associated with a first access point (AP) in a first basic service set (BSS) and associated with a first enhanced data privacy (EDP) group supported by the first AP, information associated with one or more EDP groups supported by a second AP in a second BSS. Upon roaming from the first AP in the first BSS to the second AP in the second BSS, a second EDP group of the one or more EDP groups is joined, based at least in part on the information.

### CROSS-REFERENCE TO RELATED APPLICATIONS

This application claims benefit of co-pending U.S. Provisional Patent Application Ser. No. 63/677,982, filed Jul. 31, 2024, and co-pending U.S. Provisional Patent Application Ser. No. 63/678,014 filed Jul. 31, 2024. The aforementioned related patent applications are herein incorporated by reference in their entireties for all applicable purposes.

### TECHNICAL FIELD

Embodiments presented in this disclosure generally relate to wireless communications. More specifically, embodiments disclosed herein relate to techniques for facilitating seamless roaming of enhanced data privacy wireless stations (STAs) within a network.

### BACKGROUND

In many wireless networks, clients (e.g., wireless devices or non-access point (AP) stations (STAs) (non-AP STAs)) can be susceptible to tracking by unauthorized (e.g., malicious) users. For example, an unauthorized user can gain access to a wireless network with a rogue AP and use the rogue AP to intercept packages and track the movement and activity of clients within the network based on the intercepted packets. To mitigate against such unauthorized tracking, certain wireless networks (e.g., Institute of Electrical and Electronics Engineers (IEEE) 802.11, also known as Wi-Fi) have introduced several privacy enhancements that aim to provide clients with the ability to avoid being tracked within a network. These privacy enhancements generally involve anonymizing frame parameters, such as an association identifier (AID), a medium access control (MAC) address, a packet number (PN), a sequence number (SN), among others.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system, according to certain embodiments.

FIG. 2 illustrates an example call flow for facilitating seamless roaming for enhanced data privacy (EDP) clients, according to certain embodiments.

FIG. 3 illustrates another example call flow for facilitating seamless roaming for EDP clients, according to certain embodiments.

FIG. 4 is a flowchart of a method for wireless communications, according to certain embodiments.

FIG. 5 illustrates an example computing device, according to certain embodiments.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment described herein is a computer-implemented method for wireless communications performed by a wireless station. The computer-implemented method includes obtaining, while associated with a first access point (AP) in a first basic service set (BSS) and associated with a first enhanced data privacy (EDP) group supported by the first AP, information associated with one or more EDP groups supported by a second AP in a second BSS. The computer-implemented method also includes, upon roaming from the first AP in the first BSS to the second AP in the second BSS, joining a second EDP group of the one or more EDP groups, based at least in part on the information.

Another embodiment described herein is a computing device. The computing device includes one or more memories collectively storing instructions, and one or more processors communicatively coupled to the one or more memories. The one or more processors are individually or collectively configured to execute the instructions to cause the computing device to perform an operation. The operation includes obtaining, while associated with a first access point (AP) in a first basic service set (BSS) and associated with a first enhanced data privacy (EDP) group supported by the first AP, information associated with one or more EDP groups supported by a second AP in a second BSS. The operation also includes, upon roaming from the first AP in the first BSS to the second AP in the second BSS, joining a second EDP group of the one or more EDP groups, based at least in part on the information.

Another embodiment described herein is a non-transitory computer-readable medium. The non-transitory computer-readable medium includes computer-executable code, which when executed by one or more processors of a computing device perform an operation. The operation includes obtaining, while associated with a first access point (AP) in a first basic service set (BSS) and associated with a first enhanced data privacy (EDP) group supported by the first AP, information associated with one or more EDP groups supported by a second AP in a second BSS. The operation also includes upon roaming from the first AP in the first BSS to the second AP in the second BSS, joining a second EDP group of the one or more EDP groups, based at least in part on the information.

Other embodiments provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein.

### Example Embodiments

Wireless systems are increasingly expected to protect the privacy of clients as those clients move through an extended service set (ESS) that can span multiple basic service sets (BSSs). Accordingly, certain wireless systems (e.g., IEEE 802.11bi among other wireless standards) support enhanced data privacy (EDP), which includes several privacy enhancements that aim to provide clients (also referred to as stations (STAs)) with the ability to avoid being tracked within a network. EDP involves dynamically updating various (unencrypted) wireless frame parameters associated with a client (e.g., AID, MAC address, SN, PN, among other personally identifiable information (PII) parameters) at defined time intervals, referred to herein as “epochs” or “EDP epochs.” Such periodic changes in wireless frame parameters may be referred to as frame anonymization.

Frame anonymization enables restricting presence monitoring time windows to portions of a single association between a client and AP. As such, frame anonymization may improve the client's privacy by making it difficult for an observer (e.g., attacker, malicious user, unauthorized user) to correlate the (updated) frame parameters with a client's presence across different time intervals. To support frame anonymization, each AP advertises one or more EDP groups, such that when a client associates with a BSS, the client is presented with a set of choices for EDP groups. For example, when a client joins a BSS, the AP may provide a list of current EDP groups (supported by the AP) to the client along with a respective set of EDP parameters (e.g., approximate number of clients in the EDP group, epoch interval (e.g., the duration of the epoch, such as 1 second(s), 100 s, etc.), among other information) for each EDP group. An EDP group generally refers to a group of clients (e.g., one or more clients) that rotate (or update) their wireless frame parameters synchronously, producing a “hide-in-the-crowd” effect that frustrates passive tracking by observers within the network.

In certain cases, when a client associates with a BSS, the client may be moved to a default EDP group and then send a request to join one of the EDP groups (e.g., a first EDP group from the list of current EDP groups), based on various criteria. Such criteria may include a desired level of privacy, which may be based on the number of clients in the EDP group, epoch interval for the EDP group, etc. For example, shorter epoch intervals and larger EDP groups may provide higher levels of privacy compared to longer epoch intervals and smaller EDP groups. Upon receiving the request, the AP may accept or reject the client's request to join the EDP group. Additionally, while associated with the BSS, the client and AP may build up a shared cryptographic state associated with the EDP operation. The shared cryptographic state may include parameters associated with the EDP epoch as well as the frame anonymization procedure (or configuration). Such state parameters, for example, may define how to compute the EDP epochs, perform the rotation (or update) of wireless frame parameters, etc.

While EDP operation works well while a client remains within a single BSS, there are several challenges associated with EDP operation when the client roams to another BSS within the ESS.

First, the target BSS may not support the same EDP parameters (e.g., set of EDP groups, epoch intervals, frame anonymization, etc.) as the source BSS. For example, the target BSS may support EDP group(s) with a smaller number of clients, longer epoch intervals, or a combination thereof. In another example, the target BSS may not support any EDP groups that are compatible with the client's desired level of privacy. In such examples, the client may have to choose to either compromise its level of privacy or to remain associated with the source BSS (e.g., abandon the roam), thereby impacting the client's communication performance in terms of reduced throughput, increased latency, and lower transmission range, as illustrative examples.

Second, maintaining continuity of the shared cryptographic state that underlies the next epoch frame wireless parameters (e.g., the seeds or counters used to drive the upcoming MAC address, AID, SN, PN, and so on) is non-trivial. If this shared cryptographic state is not transferred prior to the roam, the client and target AP may have to perform fresh signaling exchanges before the next epoch boundary; otherwise, the frame anonymization rotation may stall, allowing the client to become trackable.

Moreover, these challenges may create a privacy gap during roaming that is exacerbated by certain network conditions, such as dense deployments. For example, in dense network deployments, the client may roam frequently among BSSs in search of better network conditions. However, certain latency sensitive applications (e.g., voice-over-IP (VOIP), augmented reality (AR)/virtual reality (VR) applications, among others) generally cannot tolerate the delays associated with re-deriving the EDP state on each roaming event. Additionally, pre-sharing the shared cryptographic state with every neighboring BSS significantly increases signaling overhead and increases the likelihood that such parameters may be intercepted by malicious actors.

As such, certain embodiments described herein provide techniques and apparatus for facilitating seamless roaming (e.g., continuous roaming with no apparent interruption in data communication) for a client that supports EDP operation. As described in greater detail herein, certain techniques are provided that allow a client to preserve the client's EDP group parameters as the client roams among multiple BSSs within an ESS as well as maintain continuity of the shared cryptographic state associated with the client's EDP operation without adding prohibitive signaling latency or bandwidth. In this manner, the techniques described herein may allow roaming clients to maintain a consistent privacy level, reduce exposure to tracking, and avoid service interruptions that can result from repeated EDP (re) negotiations, thereby improving the client's communication performance in terms of higher throughput, decreased latency, and higher transmission range, as illustrative examples.

Although the terms “first,” “second,” “third,” etc., may be used herein to describe various elements, components, regions, layers and/or sections, these elements, components, regions, layers and/or sections should not be limited by these terms. These terms may be only used to distinguish one element, component, region, layer or section from another element, component, region, layer, or section. Terms such as “first,” “second,” and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

As used herein, a hyphenated form of a reference numeral refers to a specific instance of an element and the un-hyphenated form of the reference numeral refers to the collective element. Thus, for example, device “12-1” refers to an instance of a device class, which may be referred to collectively as devices “12” and any one of which may be referred to generically as a device “12”.

Note, the techniques described herein for facilitating seamless roaming among multiple APs within a network by a client that supports EDP operation may be incorporated into (such as implemented within or performed by) a variety of wired or wireless apparatuses (such as nodes). In some implementations, a node includes a wireless node. Such wireless nodes may provide, for example, connectivity to or from a network (such as a wide area network (WAN) such as the Internet or a cellular network) via a wired or wireless communication link. In some implementations, a wireless node may include an AP, a controller, or a STA.

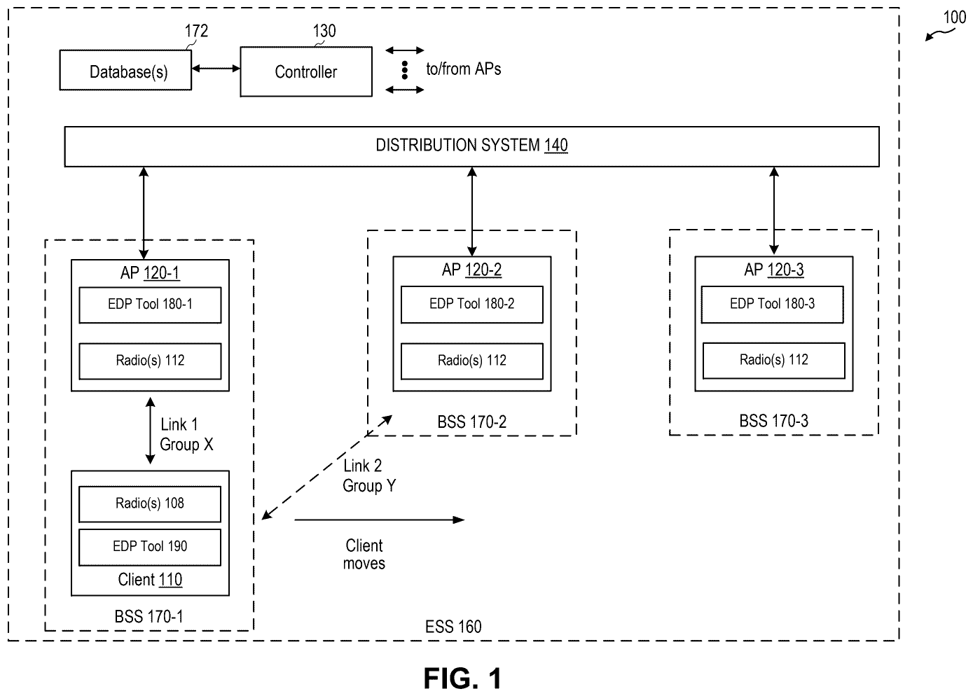

FIG. 1 illustrates an example system 100 in which one or more techniques described herein can be implemented, according to certain embodiments. In certain embodiments, the system 100 may implement a wireless network according to one or more wireless communication standards, such as one or more of the IEEE 802.11 standards. As shown, the system 100 includes, without limitation, an ESS 160 (e.g., a wireless network, such as a campus/ESS network). The ESS 160 includes one or more APs 120 (e.g., AP 120-1, AP 120-2, and AP 120-3) in one or more respective BSSs 170 (e.g., BSS 170-1, BSS 170-2, and BSS 170-3), a client 110, a distribution system (DS) 140, a controller 130, and one or more databases 172.

An AP is generally a fixed station that communicates with client(s) and may be referred to as a base station, an AP, an AP STA, a multi-link device (MLD), an AP MLD, a network entity, a wireless device, or some other terminology. A client may be fixed or mobile and also may be referred to as a STA, a client STA, a mobile STA MLD, a client MLD, a MLD, a client STA MLD, a non-AP MLD, a wireless device, or some other terminology. Note that while a certain number of APs and clients are depicted, the system 100 may include any number of APs and clients.

As used herein, an AP along with the clients associated with the AP (e.g., within the coverage area (or cell) of the AP) may be referred to as a BSS. Here, for example, the BSS 170-1 may include the AP 120-1 along with the clients 110 associated with the AP 120-1, the BSS 170-2 may include the AP 120-2 along with the clients 110 associated with the AP 120-2, and the BSS 170-3 may include the AP 120-3 along with the clients 110 associated with the AP 120-3. The AP 120-1, AP 120-2, and AP 120-3 may be neighboring (peer) APs. The APs 120 may communicate with one or more clients 110 on the downlink and uplink. The downlink (e.g., forward link(s)) is the communication link(s) from the AP 120 to the client(s) 110, and the uplink (e.g., reverse link(s)) is the communication link(s) from the client(s) 110 to the AP 120. In some cases, a client may also communicate peer-to-peer with another client.

As shown in FIG. 1, the client 110 includes one or more radios 108. The client 110 can use one or more of the radios 108 to form links with an AP(s) 120. As also shown, each AP 120 includes one or more radios 112 that the AP 120 can use to form links with one or more clients 110 and/or one or more APs 120. In general, the AP(s) 120 and the client(s) 110 may form any suitable number of links for communication using any suitable frequencies and using any suitable communication protocols. In some instances, a client 110 may form multiple links with a single AP 120.

The term “radio” may refer to the capability to connect to a peer device on a link. By way of example, the radios 112 may represent physical radios or logical radios enabled by a single physical radio (which is capable of being used on multiple different links in a time-switched fashion). Similarly, the radios 108 may represent physical radios or logical radios enabled by a single physical radio (which is capable of being used on multiple different links in a time-switched fashion).

In certain cases, the AP(s) 120 and the client 110 may be capable of performing multi-link operations (MLO). That is, the AP(s) 120 may be configured as AP MLDs and the client 110 may be configured as a STA MLD. In certain cases, the client 110 may form multiple links across multiple APs 120. For example, a client 110 can use a first radio 108 operating on a first band (e.g., 5 GHz band) to establish a first link with AP 120-1 and use a second radio 108 operating on a second band to establish a second link with AP 120-2. In general, each client 110 may establish multiple communication links across one or more APs 120. Similarly, each AP 120 may establish multiple communication links across one or more clients 110.

A MLD may generally be classified based on whether it is a single radio MLD or multi-radio MLD. Single radio MLDs generally use a single radio to switch between one or more links. One category of single radio MLDs is Enhanced Multi-Link Single Radio (eMLSR). eMLSR devices generally operate one main wireless radio that can transmit and/or receive data frames on a given link, but can detect some data (e.g., short initial frames) on a set of other links when the device is not actively transmitting or receiving. Multi-radio MLDs may generally be classified into the following two types: (i) simultaneous transmission and reception (STR) MLD and (ii) non-STR MLD. For STR MLDs, a transmission on one link may not affect the operations of frame reception and clear channel assessment (CCA) on other links. Stated differently, for STR MLDs, individual links can operate independently of each other. For non-STR MLDs, operation on one link may be restricted by operation on another link. For example, a transmission on one link may not be allowed if it will cause reception interruption on another link. In another example, a reception or CCA on one link may not be allowed if a transmission is ongoing on another link.

In certain cases, the APs 120 may be controlled or managed at least partially by the controller 130. Here, the controller 130 couples to and provides coordination and control for the APs 120 1-3. For example, the controller 130 may handle adjustments to RF power, channels, authentication, and security for the APs 120. In certain embodiments, the controller 130 may also coordinate the links formed by the APs 120. In certain embodiments, the controller 130 may also control, manage, and/or coordinate EDP operation for the ESS 160, as described in greater detail herein. Each AP 120 may maintain a respective connection to the DS 140, which may be configured to manage communications among multiple APs. In certain embodiments, the DS 140 may include or otherwise be implemented by the controller 130.

The operations of the controller 130 may be implemented by any device or system, and may be combined or distributed across any number of systems. For example, the controller 130 may be a wireless local area network (WLAN) controller for the deployment of APs 120 within the system 100. In some examples, the controller 130 is included within or integrated with an AP 120 and coordinates the links formed by that AP 120 (or otherwise provides control for that AP). For example, each AP 120 may include a controller that provides control for that AP. In some embodiments, the controller 130 is separate from the APs 120 and provides control for those APs. In FIG. 1, for example, the controller 130 may communicate with the APs 120 1-3 via a (wired or wireless) backhaul, such as the DS 140. The APs 120 1-3 may also communicate with one another, e.g., directly or indirectly via a wireless or wireline backhaul, such as the DS 140. The database(s) 172 are representative of storage systems that may include, without limitation, radio resource configurations, radio resource management (RRM) information, wireless frame parameters, EDP parameters, among other information.

In certain embodiments, one or more of the clients 110 and APs 120 may support EDP, which includes several privacy enhancements that aim to provide clients 110 with the ability to avoid being tracked within a network. As part of EDP, the AP(s) 120 and/or clients 110 may dynamically update various (unencrypted) wireless frame parameters at defined time intervals (also referred to herein as epochs). For example, a client 110 assigned to (or otherwise associated with) a given EDP group may update one or more wireless frame parameters at each epoch according to EDP parameters associated with the EDP group.

As noted, however, while EDP operation works well while a client 110 remains within a single BSS (e.g., BSS 170-1), there are several challenges associated with EDP operation when the client roams to another BSS (e.g., BSS 170-2, BSS 170-3, etc.) within the ESS 160. In certain cases, for example, the target BSS to which the client roams may not support the same EDP parameters as the source (or previous) BSS. Additionally, maintaining continuity of the shared cryptographic state associated with the client's EDP operation during roaming events may be inefficient, leading to delays that impact the client's communication performance, and in turn, the client's ability to seamlessly roam within the network during EDP operation.

To address this, certain embodiments provide techniques that allow a client 110 to preserve the client's EDP group parameters as the client 110 roams among multiple BSSs 170 within an ESS 160 as well as maintain continuity of the shared cryptographic state associated with the client's EDP operation without adding prohibitive signaling latency or bandwidth. As depicted in FIG. 1, each AP 120 includes a respective EDP tool 180, which is configured to perform one or more techniques described herein and is described in greater detail below. The EDP tool 180 may be implemented with hardware, software, or combinations thereof. As also shown, the client 110 includes an EDP tool 190, which is configured to perform one or more techniques described herein and is described in greater detail below. The EDP tool 190 may be implemented with hardware, software, or combinations thereof.

In certain embodiments, the APs 120 may communicate amongst themselves to exchange each other's EDP information (e.g., number of EDP groups, EDP group identifiers (IDs), number of clients within each EDP group, epoch interval of each EDP group, frame anonymization procedure for each EDP group, among other information). Each AP 120 may then provide an indication of one or more neighbor AP's EDP information to an associated client 110 to allow the client 110 to have visibility to each neighbor AP's EDP information when roaming throughout the ESS 160.

As illustrated in FIG. 1, the client 110 is initially associated with AP 120-1 in BSS 170-1 and may perform communications via a first link (link 1) established between AP 120-1 and client 110. As part of (or after) associating with the AP 120-1, the client 110 may join an EDP group X supported by the AP 120-1. The client 110 may also receive, from AP 120-1, EDP information associated with AP 120-2 in BSS 170-2 and AP 120-3 in BSS 170-3.

In certain embodiments, when a client 110 roams to another AP 120 (BSS 170), the client 110 may determine which EDP group of the neighbor AP 120 to join, based in part on the obtained EDP information. For example, as illustrated in FIG. 1, the client 110 roams from AP 120-1 to AP 120-2 (BSS2) and associates with AP 120-2. The client 110 may determine to join an EDP group Y, based on the EDP information associated with AP 120-2 obtained from AP 120-1. For example, the client 110 may select an EDP group Y on AP 120-2 that has similar (or same) parameters as the EDP group X on AP 120-1. Accordingly, by enabling APs 120 to provide clients 110 with EDP information associated with one or more neighbor APs 120, techniques described herein can allow clients 110 to proactively join EDP groups that preserve the client's desired privacy level.

To maintain continuity of the shared cryptographic state associated with the client's EDP operation, certain embodiments described herein provide techniques for automatically providing (or creating) cryptographic state information from the client's source AP on the target AP, e.g., while the client 110 is still associated with the source AP.

For example, in certain embodiments, the client 110 may request the source AP (BSS) (e.g., AP 120-1 in BSS 170-1) to transfer certain state parameters to the target AP (BSS) (e.g., AP 120-2 in BSS 170-2), e.g., via the DS 140. In other embodiments, the client 110 may request, through the source AP, the target AP to create a new set of EDP parameters for the client 110, while the client 110 is still associated with the source AP. In other embodiments, all APs 120 in the same ESS 160 may be configured to share their respective state information (e.g., EDP group IDs and parameters). In such embodiments, whenever an EDP group is created, this information can be made available to all other APs in the same BSS. The client 110 can then be automatically provisioned in the target AP with the previous parameters from the source AP.

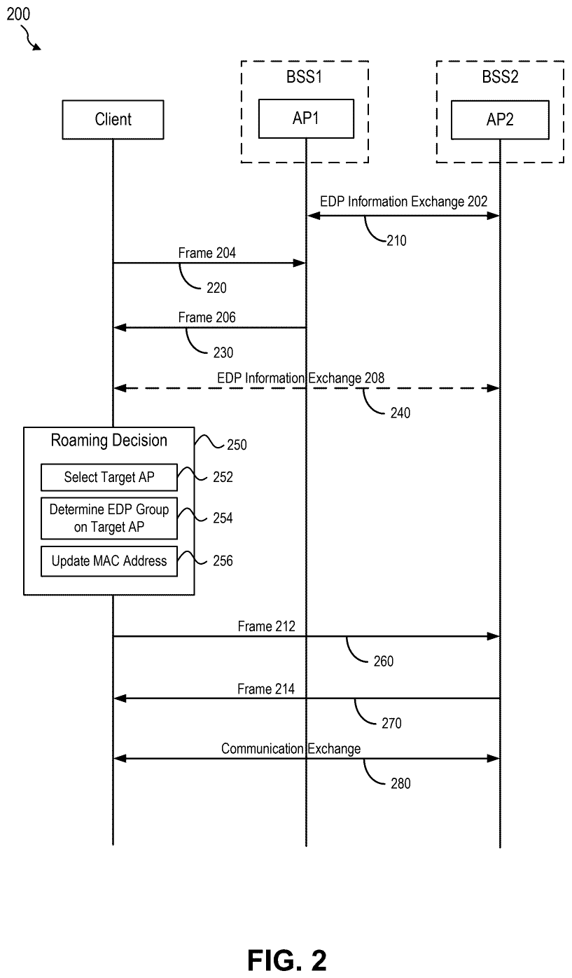

FIG. 2 illustrates an example call flow 200 for facilitating seamless roaming of a client during EDP operation, according to certain embodiments. Here, the call flow 200 depicts example operations by a source AP (e.g., AP1, such as AP 120-1) within a first BSS (e.g., BSS1, such as BSS 170-1), a target AP (e.g., AP2, such as AP 120-2) within a second BSS (e.g., BSS2, such as BSS 170-2), and a client (e.g., client 110).

As noted, in certain cases, the client may be initially associated with AP1 (in BSS1), and may request to join one of the EDP groups (e.g., EDP group X) supported by AP1. At a subsequent point in time, the client may roam from AP1 to AP2 (in BSS2) and may join one of the EDP groups (e.g., EDP group Y) supported by AP2.

In certain embodiments, each AP may be configured to exchange the AP's EDP information with one or more neighbor APs. By way of example, as illustrated at step 210, AP1 and AP2 may exchange their respective EDP information with each other (illustrated as EDP information exchange 202 in FIG. 2). The EDP information that is exchanged may include (i) a number of EDP groups supported by the AP, (ii) an identifier for each EDP group (e.g., EDP group ID) supported by the AP, (iii) a number of clients (STA count) for each EDP group supported by the AP, (iv) an epoch interval of each EDP group supported by the AP, (v) the frame anonymization procedure (or configuration) (e.g., which wireless frame parameters are rotated (or updated)) for each EDP group supported by the AP, or (vi) any combination thereof. In certain embodiments, the EDP information exchange 202 is performed using a wireless or wireline backhaul, such as the DS 140 illustrated in FIG. 1.

In certain embodiments, the client may obtain, from AP1, information about the available EDP groups on one or more neighbor APs, such as AP2. By way of example, as illustrated at step 220, the client may transmit a frame 204 to AP1 that includes a request for neighbor AP information (e.g., “neighbor report” request). In certain embodiments, the frame 204 has a same or similar format as an 802.11k neighbor report request. In certain embodiments, the request for neighbor AP information within frame 204 may include a request for EDP information of the neighbors of AP1. For example, in some such embodiments, the frame 204 may use a modified 802.11k neighbor report request format that includes an indication that EDP information is being requested for one or more neighbor APs.

As illustrated at step 230, the client may receive, in response to frame 204, a frame 206 from AP1 that includes the requested neighbor AP information along with respective EDP information for each neighbor AP. In certain embodiments, the frame 206 is a modified 802.11k neighbor report that includes respective EDP information for one or more neighbor APs, such as AP2. For example, the frame 206 may include, for each neighbor AP, a basic service set identifier (BSSID), channel information, and EDP information (e.g., EDP group IDs, STA count for each EDP group, epoch interval for each EDP group, frame anonymization procedure for each EDP group, etc.).

In certain embodiments, to reduce the size of the frame 206, AP1 may provide, for each neighbor AP, an indication of one or more suggested EDP groups supported by the neighbor AP within the frame 206, e.g., as opposed to indicating every supported EDP group for the neighbor AP. The suggested EDP group(s) may be EDP group(s) that provide same (or similar) EDP privacy level as the current EDP group of the client or a better (higher) EDP privacy level than the current EDP group of the client. For example, the suggested EDP group(s) may have an epoch interval that is less than or equal to the epoch interval of the client's current EDP group, a STA count that is greater than or equal to the STA count of the client's current EDP group, or a combination thereof.

Additionally or alternatively, in certain embodiments, AP1 may order (or rank) the list of EDP groups for each neighbor AP, such that EDP group(s) having same (or similar) or better EDP privacy level than the client's EDP group are indicated higher within the list of EDP groups. In some embodiments, the AP1 may include EDP groups having an EDP privacy level greater than (or equal to) a threshold and omit other EDP groups having an EDP privacy level less than (or equal to) the threshold.

In certain embodiments, the client may directly or indirectly communicate with the neighbor AP(s) in order to obtain each neighbor AP's EDP information. By way of example, as illustrated at 240, the client and AP2 may participate in an EDP information exchange 208. In certain embodiments, the EDP information exchange 208 involves (or is based on) an 802.11r fast transition procedure. For example, the 802.11r fast transition procedure may be extended (or modified) to allow the client to request a particular EDP group ID or desired (or target) EDP group parameters from AP2, while the client is still associated with AP1 and prior to (re) association to AP2. In some cases, the EDP information exchange 208 between the client and AP2 may involve indirect communications via AP1, e.g., using over the DS signaling. In other cases, the EDP information exchange 208 between the client and AP2 may involve direct communication, e.g., using over-the-air (OTA) signaling.

As illustrated at step 250, the client makes a roaming decision that involves selecting a target AP (BSS), such as AP2 (BSS2), to roam to (step 252), e.g., based on the frame 206. Here, for example, the client may select AP2 as a target AP from a set of one or more available neighbor APs. Additionally, the roaming decision may include determining (or selecting) an EDP group on the target AP to join (step 254), based at least in part on the EDP information for the target AP obtained via the frame 206 and/or the EDP information exchange 208.

In certain embodiments, if the selected EDP group on AP2 has a matching EDP group ID and/or matching set of parameters as the client's current EDP group on AP1 (e.g., in case the EDP group is pre-configured and/or synchronized across the ESS, for instance in a controller-based scenario), then the client may (re) associate to AP2 expressing no EDP group preference (implicit EDP group selection). In some such embodiments, AP2 may ensure that the client joins an EDP group that is equivalent to the client's current EDP group on AP1.

In certain embodiments, if the client identifies an EDP group on AP2, different than the client's current EDP group in use on AP1, then the client may request to join the desired EDP group using a (re) association request frame. By way of example, as illustrated at step 260, the client transmits a frame 212 to the AP2. In certain embodiments, the frame 212 is a (re) association request frame that includes, without limitation, a request to join the EDP group selected by the client. In other embodiments, the frame 212 is a (re) association request frame that includes, without limitation, a set of desired EDP parameters. For example, if the client does not identify a suitable EDP group among the available EDP groups on AP2, then the client may indicate the desired EDP group parameters via the frame 212. In some such embodiments, the AP2 may select an EDP group for the client that has same (or similar) EDP parameters as the requested EDP parameters from the client. For example, the AP2 may select an EDP group that provides a same (or similar) or better EDP privacy level associated with the requested EDP parameters.

In certain cases, a malicious actor may be able to track the client's movement when the client uses the same MAC address when roaming from a source AP to a target AP. In certain embodiments, to prevent (or at least reduce the likelihood of) the client's movement from being tracked, the client may update its MAC address when roaming and inform the target AP of the client's updated MAC address using over the DS signaling (step 256).

As illustrated at step 270, in response to the frame 212, AP2 may transmit a frame 214 to the client indicating which EDP group that the client has joined. For example, the frame 212 may be a (re) association response frame that confirms the client's request to join the requested EDP group and that indicates the next epoch start time. As illustrated at step 280, the client and AP2 exchange communications with each other, according to EDP information of the EDP group that the client joined.

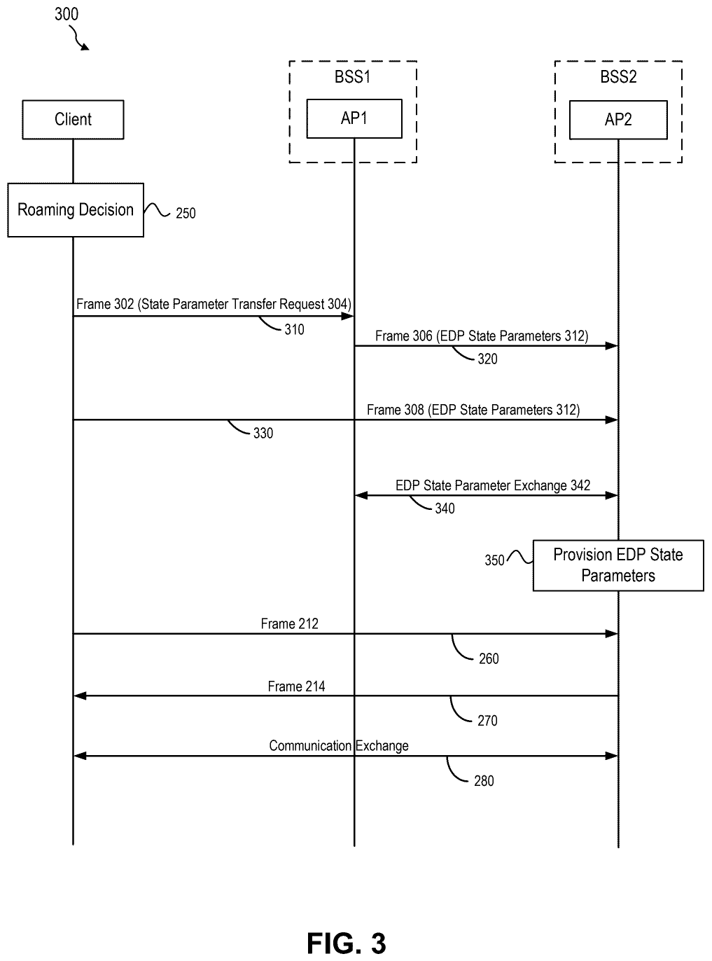

FIG. 3 illustrates an example call flow 300 for facilitating seamless roaming of a client during EDP operation, according to certain embodiments. Here, the call flow 300 depicts example operations by a source AP (e.g., AP1, such as AP 120-1) within a first BSS (e.g., BSS1, such as BSS 170-1), a target AP (e.g., AP2, such as AP 120-2) within a second BSS (e.g., BSS2, such as BSS 170-2), and a client (e.g., client 110).

In certain embodiments, the call flow 300 may include one or more of the operations depicted in call flow 200. For example, the call flow 300 may include the roaming decision at step 250, the transmission of frame 212 at step 260, the transmission of frame 214 at step 270, and/or the communication exchange at step 280.

Additionally, note that, in certain embodiments, the call flow 300 may be used for mass/group rotation scenarios and/or individual rotation scenarios. In mass/group rotation scenarios, the client associated with a source BSS and within a particular EDP group in the source BSS may roam to a target BSS. In individual rotation scenarios, a client may be associated with a source BSS and may have a number of EDP settings for its own individual use. That is, the client may not wish to join a particular EDP group, but may support frame anonymization with client specific parameters.

As noted, in certain cases, when a client requests to join another EDP group of a target AP, the client may want to maintain continuity of the cryptographic state information generated from the client's previous association with the source AP, e.g., to avoid having to re-establish state parameters (including parameters for EDP epochs) in the target AP.

As such, in certain embodiments, the client may request the source AP to transfer the client's existing state parameters to the target AP. By way of example, as illustrated at step 310, the client may send a frame 302 to AP1 that includes a state parameter transfer request 304. The state parameter transfer request 304 may include a request for AP1 to transfer the client's existing state parameters to the target AP, such as AP2. Upon receiving the frame 302, AP1 may send a frame 306 including the client's EDP state parameters 312 to AP2. In certain embodiments, the EDP state parameters 312 may include the client's preexisting state parameters established during the client's association with AP1 (except for AP-defined AIDs that are BSS specific). In certain embodiments, the frame 306 may be sent to the AP2 over the DS 140. In this manner, the client does not have to flush its existing cryptographic state information when roaming to a different target AP.

In certain embodiments, rather than request the source AP to transfer the client's existing state parameters to the target AP, the client may request, via the source AP, the target AP to create a new set of EDP parameters, while the client is associated with the source AP. By way of example, as illustrated at step 330, the client may transmit a frame 308 including the EDP state parameters 312 to the AP2. Note that while FIG. 3 depicts the frame 308 being sent directly from the client to AP2, in certain embodiments, the frame 308 may be sent to the AP2 indirectly, e.g., via AP1. For example, the frame 308 may be sent using an over the DS mechanism in 802.11r.

In certain embodiments, the client may send one or more action frames to the target AP to pre-establish the client's EDP state parameters on the target AP. By way of example, as illustrated at step 330, the client may transmit a frame 308 including EDP state parameters 312 to the AP2, while the client is still associated with AP1. In certain embodiments, the frame 308 may be transmitted using an OTA mechanism similar to the OTA mechanism defined in 802.11r.

In certain embodiments, each BSS 170 in the same ESS 160 may share the EDP state parameters, e.g., in a controller-based deployment, using a central database, using AP-to-AP signaling, or via a distributed database. In this way, whenever an EDP group is created, the EDP state parameters may be made available to all other BSSs 170 in the ESS 160. By way of example, as illustrated at step 340, AP1 and AP2 may perform an EDP state parameter exchange 342 to exchange the client's EDP state parameters. In certain embodiments, the capability of an AP (BSS) to automatically share the client's EDP state parameters may be advertised to the client using an indication in a beacon, association response, or another type of frame.

As illustrated at step 350, AP2 may provision the EDP state parameters (e.g., EDP state parameters 312) in BSS2. For example, assuming AP2 obtains the EDP state parameters 312 via the frame 306, the AP2 may provision the same privacy parameters as in BSS1 for the client. Note, the EDP state parameters 312 may include group parameters or an individual set of parameters. In another example, assuming AP2 obtains the EDP state parameters 312 via the frame 308, the AP2 may provision the parameters in BSS2, such that when the client associates with AP2, the client does not have to send separate signaling to establish the EDP state parameters 312. In yet another example, assuming AP2 obtains the EDP state parameters 312 via the EDP state parameter exchange 342, the client may be automatically provisioned in BSS2 with the EDP state parameters from BSS1, e.g., when the client associates with AP2.

Note that, in certain cases, the individual scenario can be described as a single-member/individual group. In order to support individual groups, a specific group ID may be reserved when the roaming occurs. The target AP may then receive the individual EDP group parameters as part of the STA context transfer.

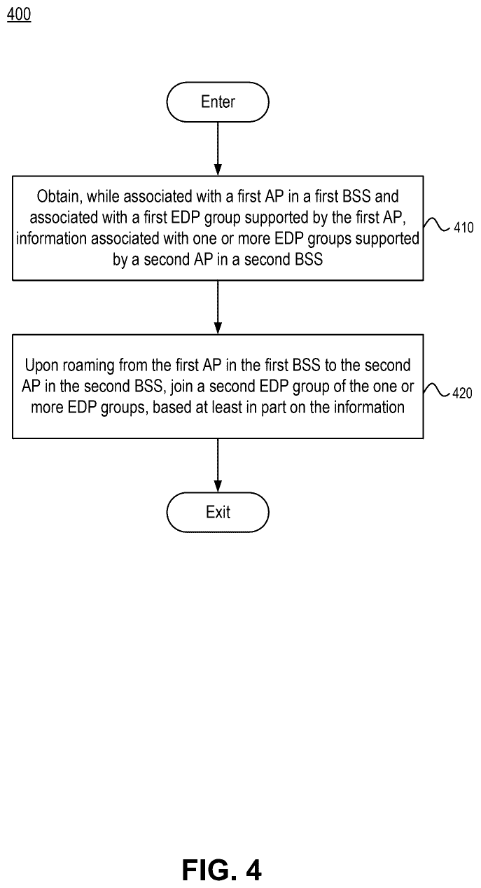

FIG. 4 is a flowchart of a method 400 for performing wireless communications, according to certain embodiments. The method 400 may be performed by a client (e.g., client 110).

Method 400 enters at block 410, where the client obtains, while the client is associated with a first AP in a first BSS and associated with a first EDP group supported by the first AP, information associated with one or more EDP groups supported by a second AP in a second BSS.

At block 420, the client, upon roaming from the first AP in the first BSS to the second AP in the second BSS, joins a second EDP group of the one or more EDP groups, based at least in part on the information.

In certain embodiments, obtaining the information includes: (i) transmitting a request for the information to the second AP; and (ii) receiving a response comprising the information from the second AP.

In certain embodiments, obtaining the information includes receiving a frame comprising the information from the first AP. In some such embodiments, the frame includes a neighbor report message. Additionally or alternatively, in some such embodiments, the frame includes a ranked order of the one or more EDP groups from highest privacy level to lowest privacy level. Additionally or alternatively, in some such embodiments, the frame includes a recommendation of the second EDP group among the one or more EDP groups.

In certain embodiments, the information includes at least one of (i) a total number of the one or more EDP groups, (ii) a respective identifier for each of the one or more EDP groups, (iii) a respective station count for each of the one or more EDP groups, (iv) a respective epoch interval for each of the one or more EDP groups, or (v) a respective frame anonymization configuration for each of the one or more EDP groups.

In certain embodiments, the method 400 further includes: (i) determining, based on the information, a respective privacy level associated with each of the one or more EDP groups; and (ii) selecting the second EDP group upon determining that the privacy level of the second EDP group is greater than or equal to a privacy level of the first EDP group.

In certain embodiments, roaming from the first AP to the second AP includes sending an association request to the second AP, and joining the second EDP group involves including an indication of the second EDP group in the association request.

In certain embodiments, roaming from the first AP to the second AP includes sending an association request to the second AP, and joining the second EDP group includes: (i) including an indication of a target set of EDP parameters in the association request; and (ii) receiving, in response to the association request, a response indicating that the wireless station has been assigned to the second EDP group.

In certain embodiments, the method 400 further includes: (i) updating a MAC address of the wireless station upon roaming from the first AP to the second AP; and (ii) sending an indication of the updated MAC address to the second AP.

In certain embodiments, the method 400 includes: (i) transmitting, to the first AP and while associated with the first AP, a request for the first AP to transfer EDP state information associated with the wireless station to the second AP; and (ii) upon roaming to the second AP, performing communications in the second BSS in accordance with the transferred EDP state information.

In certain embodiments, the method 400 includes: (i) performing communications in the first BSS in accordance with a first EDP state information; (ii) transmitting, while associated with the first AP, a request for the second AP to generate second EDP state information for the wireless station to use in the second BSS, wherein the second EDP state information has a same set of parameters as the first EDP state information; and (iii) upon roaming to the second AP, performing communications in the second BSS in accordance with the second EDP state information.

In certain embodiments, the method 400 includes: (i) upon roaming to the second AP, receiving, from the second AP, EDP state information that was previously used by the wireless station in the first BSS; and (ii) performing communications in the second BSS in accordance with the EDP state information.

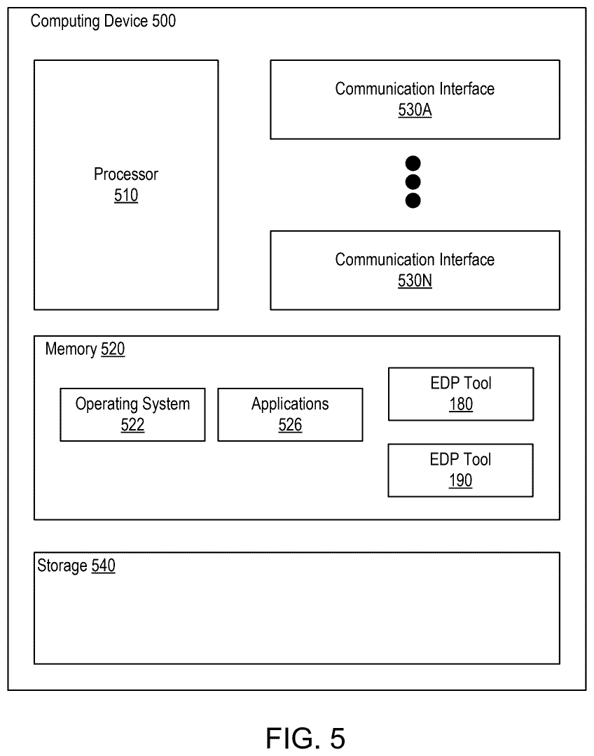

FIG. 5 illustrates an example computing device 500, according to one embodiment. The computing device 500 can be configured to perform one or more techniques described herein. For example, the computing device 500 can perform certain operations depicted in call flow 200, call flow 300, method 400, and any other techniques (or combination of techniques) described herein. The computing device 500 may be representative of a controller (e.g., controller 130), a network entity (e.g., an AP, such as AP 120), or a client (e.g., client 110). The computing device 500 includes, without limitation, a processor 510, a memory 520, one or more communication interfaces 530a-n. In one example, a communication interface 530 includes a radio.

The processor 510 may be any processing element capable of performing the functions described herein. The processor 510 represents a single processor, multiple processors, a processor with multiple cores, and combinations thereof. The communication interfaces 530 (e.g., radios) facilitate communications between the computing device 500 and other devices. The communications interfaces 530 may include wireless communications antennas and various wired communication ports.

The memory 520 may be either volatile or non-volatile memory and may include RAM, flash, cache, disk drives, and other computer readable memory storage devices. Although shown as a single entity, the memory 520 may be divided into different memory storage elements such as RAM and one or more hard disk drives. As shown, the memory 520 includes various instructions that are executable by the processor 510 to provide an operating system 522 to manage various functions of the computing device 500. The memory 520 also includes one or more application(s) 526. In certain embodiments, the memory 520 includes an EDP tool 180. In other embodiments, the memory 520 includes an EDP tool 190.

The computing device 500 may include storage 540. In some cases, the storage 540 may be a disk drive or flash storage device. In some cases, the storage 540 may be a combination of fixed and/or removable storage devices, such as fixed disc drives, solid state drives, removable memory cards, optical storage, network attached storage (NAS), or a storage area-network (SAN).

### Example Clauses

Implementation examples are described in the following numbered clauses:

Clause 1: A computer-implemented method for wireless communications performed by a wireless station, comprising: obtaining, while associated with a first access point (AP) in a first basic service set (BSS) and associated with a first enhanced data privacy (EDP) group supported by the first AP, information associated with one or more EDP groups supported by a second AP in a second BSS; and upon roaming from the first AP in the first BSS to the second AP in the second BSS, joining a second EDP group of the one or more EDP groups, based at least in part on the information.

Clause 2: The computer-implemented method of Clause 1, wherein obtaining the information comprises: transmitting a request for the information to the second AP; and receiving a response comprising the information from the second AP.

Clause 3: The computer-implemented method in accordance with any of Clauses 1-2, wherein obtaining the information comprises receiving a frame comprising the information from the first AP.

Clause 4: The computer-implemented method of Clause 3, wherein the frame comprises a neighbor report message.

Clause 5: The computer-implemented method in accordance with any of Clauses 3-4, wherein the frame comprises a ranked order of the one or more EDP groups from highest privacy level to lowest privacy level.

Clause 6: The computer-implemented method in accordance with any of Clauses 3-5, wherein the frame comprises a recommendation of the second EDP group among the one or more EDP groups.

Clause 7: The computer-implemented method in accordance with any of Clauses 1-6, wherein the information comprises at least one of (i) a total number of the one or more EDP groups, (ii) a respective identifier for each of the one or more EDP groups, (iii) a respective station count for each of the one or more EDP groups, (iv) a respective epoch interval for each of the one or more EDP groups, or (v) a respective frame anonymization configuration for each of the one or more EDP groups.

Clause 8: The computer-implemented method in accordance with any of Clauses 1-7, further comprising: determining, based on the information, a respective privacy level associated with each of the one or more EDP groups; and selecting the second EDP group upon determining that the privacy level of the second EDP group is greater than or equal to a privacy level of the first EDP group.

Clause 9: The computer-implemented method in accordance with any of Clauses 1-8, wherein: roaming from the first AP to the second AP comprises sending an association request to the second AP; and joining the second EDP group comprises including an indication of the second EDP group in the association request.

Clause 10: The computer-implemented method in accordance with any of Clauses 1-8, wherein: roaming from the first AP to the second AP comprises sending an association request to the second AP; and joining the second EDP group comprises: including an indication of a target set of EDP parameters in the association request; and receiving, in response to the association request, a response indicating that the wireless station has been assigned to the second EDP group.

Clause 11: The computer-implemented method in accordance with any of Clauses 1-10, further comprising: updating a medium access control (MAC) address of the wireless station upon roaming from the first AP to the second AP; and sending an indication of the updated MAC address to the second AP.

Clause 12: The computer-implemented method in accordance with any of Clauses 1-11, further comprising: transmitting, to the first AP and while associated with the first AP, a request for the first AP to transfer EDP state information associated with the wireless station to the second AP; and upon roaming to the second AP, performing communications in the second BSS in accordance with the transferred EDP state information.

Clause 13: The computer-implemented method in accordance with any of Clauses 1-11, further comprising: performing communications in the first BSS in accordance with a first EDP state information; transmitting, while associated with the first AP, a request for the second AP to generate second EDP state information for the wireless station to use in the second BSS, wherein the second EDP state information has a same set of parameters as the first EDP state information; and upon roaming to the second AP, performing communications in the second BSS in accordance with the second EDP state information.

Clause 14: The computer-implemented method in accordance with any of Clauses 1-13, further comprising: upon roaming to the second AP, receiving, from the second AP, EDP state information that was previously used by the wireless station in the first BSS; and performing communications in the second BSS in accordance with the EDP state information.

Clause 15: A computing device comprising: one or more memories collectively storing instructions; and one or more processors communicatively coupled to the one or more memories, the one or more processors being individually or collectively configured to execute the instructions to cause the computing device to perform a method in accordance with any of Clauses 1-14.

Clause 16: A non-transitory computer-readable medium comprising computer-executable code, which when executed by one or more processors of a computing device perform a method in accordance with any of Clauses 1-14.

Clause 17: An apparatus comprising means for performing a method in accordance with any of Clauses 1-14.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A computer-implemented method for wireless communications performed by a wireless station, comprising:
obtaining, while associated with a first access point (AP) in a first basic service set (BSS) and associated with a first enhanced data privacy (EDP) group supported by the first AP, information associated with one or more EDP groups supported by a second AP in a second BSS; and
upon roaming from the first AP in the first BSS to the second AP in the second BSS, joining a second EDP group of the one or more EDP groups, based at least in part on the information.

2. The computer-implemented method of claim 1, wherein obtaining the information comprises:
transmitting a request for the information to the second AP; and
receiving a response comprising the information from the second AP.

3. The computer-implemented method of claim 1, wherein obtaining the information comprises receiving a frame comprising the information from the first AP.

4. The computer-implemented method of claim 3, wherein the frame comprises a neighbor report message.

5. The computer-implemented method of claim 3, wherein the frame comprises a ranked order of the one or more EDP groups from highest privacy level to lowest privacy level.

6. The computer-implemented method of claim 3, wherein the frame comprises a recommendation of the second EDP group among the one or more EDP groups.

7. The computer-implemented method of claim 1, wherein the information comprises at least one of (i) a total number of the one or more EDP groups, (ii) a respective identifier for each of the one or more EDP groups, (iii) a respective station count for each of the one or more EDP groups, (iv) a respective epoch interval for each of the one or more EDP groups, or (v) a respective frame anonymization configuration for each of the one or more EDP groups.

8. The computer-implemented method of claim 1, further comprising:
determining, based on the information, a respective privacy level associated with each of the one or more EDP groups; and
selecting the second EDP group upon determining that the privacy level of the second EDP group is greater than or equal to a privacy level of the first EDP group.

9. The computer-implemented method of claim 1, wherein:
roaming from the first AP to the second AP comprises sending an association request to the second AP; and
joining the second EDP group comprises including an indication of the second EDP group in the association request.

10. The computer-implemented method of claim 1, wherein:
roaming from the first AP to the second AP comprises sending an association request to the second AP; and
joining the second EDP group comprises:
including an indication of a target set of EDP parameters in the association request; and
receiving, in response to the association request, a response indicating that the wireless station has been assigned to the second EDP group.

11. The computer-implemented method of claim 1, further comprising:
updating a medium access control (MAC) address of the wireless station upon roaming from the first AP to the second AP; and
sending an indication of the updated MAC address to the second AP.

12. The computer-implemented method of claim 1, further comprising:
transmitting, to the first AP and while associated with the first AP, a request for the first AP to transfer EDP state information associated with the wireless station to the second AP; and
upon roaming to the second AP, performing communications in the second BSS in accordance with the transferred EDP state information.

13. The computer-implemented method of claim 1, further comprising:
performing communications in the first BSS in accordance with a first EDP state information;
transmitting, while associated with the first AP, a request for the second AP to generate second EDP state information for the wireless station to use in the second BSS, wherein the second EDP state information has a same set of parameters as the first EDP state information; and
upon roaming to the second AP, performing communications in the second BSS in accordance with the second EDP state information.

14. The computer-implemented method of claim 1, further comprising:
upon roaming to the second AP, receiving, from the second AP, EDP state information that was previously used by the wireless station in the first BSS; and
performing communications in the second BSS in accordance with the EDP state information.

15. A computing device comprising:
one or more memories collectively storing instructions; and
one or more processors communicatively coupled to the one or more memories, the one or more processors being individually or collectively configured to execute the instructions to cause the computing device to perform an operation comprising:
obtaining, while associated with a first access point (AP) in a first basic service set (BSS) and associated with a first enhanced data privacy (EDP) group supported by the first AP, information associated with one or more EDP groups supported by a second AP in a second BSS; and
upon roaming from the first AP in the first BSS to the second AP in the second BSS, joining a second EDP group of the one or more EDP groups, based at least in part on the information.

16. The computing device of claim 15, wherein obtaining the information comprises:
transmitting a request for the information to the second AP; and
receiving a response comprising the information from the second AP.

17. The computing device of claim 15, wherein obtaining the information comprises receiving a frame comprising the information from the first AP.

18. The computing device of claim 15, wherein the information comprises at least one of (i) a total number of the one or more EDP groups, (ii) a respective identifier for each of the one or more EDP groups, (iii) a respective station count for each of the one or more EDP groups, (iv) a respective epoch interval for each of the one or more EDP groups, or (v) a respective frame anonymization configuration for each of the one or more EDP groups.

19. The computing device of claim 15, the operation further comprising:
determining, based on the information, a respective privacy level associated with each of the one or more EDP groups; and
selecting the second EDP group upon determining that the privacy level of the second EDP group is greater than or equal to a privacy level of the first EDP group.

20. A non-transitory computer-readable medium comprising computer-executable code, which when executed by one or more processors of a computing device perform an operation comprising:
obtaining, while associated with a first access point (AP) in a first basic service set (BSS) and associated with a first enhanced data privacy (EDP) group supported by the first AP, information associated with one or more EDP groups supported by a second AP in a second BSS; and
upon roaming from the first AP in the first BSS to the second AP in the second BSS, joining a second EDP group of the one or more EDP groups, based at least in part on the information.
